(19) United States
(12) Patent Application Publication
(10) Pub. No.: US 2012/0073443 A1
(43) Pub. Date: Mar. 29, 2012

(54) UNITARY SORBENT CANISTER WITH THIN END WALL

(75) Inventors: Thomas J. Hurley, Kenmore, NY (US); Karen H. Calaman, Lewiston, NY (US)

(73) Assignee: MULTISORB TECHNOLOGIES, INC., Buffalo, NY (US)

(21) Appl. No.: 12/889,057

(22) Filed: Sep. 23, 2010

(51) Int. Cl. B01D 53/04; B01D 53/14; B65B 1/04

(52) U.S. Cl. 96/117.5; 96/108; 53/467; 96/243

(57) ABSTRACT

A sorbent container includes a permeable plastic container, a permeable membrane, and a sorbent. The permeable plastic container includes a sidewall and an endwall, the sidewall defining an opening opposite the endwall. The permeable membrane is fused to the sidewall to cover the opening. A fused junction is formed between the sidewall and the permeable membrane. The sorbent is disposed within the plastic container.

### BACKGROUND OF THE INVENTION

1. Field of the Invention

This invention relates generally to sorbent containers, and more particularly to a sorbent container that reduces the detrimental effects of dusting and allows for viewing contents contained within the canister.

2. Description of Related Art

Sorbent containers for use in food or pharmaceutical products as well as other applications have a number of problems. One problem is that the sorbent material disposed within the container may be comprised of very fine particles that may escape from the container and contaminate the products the sorbent container is designed to protect. This is especially true when, as in some conventional containers, a cap is snap or press fit onto a hollow cup or container housing the sorbent. Because of the relatively small size of the parts, it is difficult to retain a good sealing engagement with snap fitting, such that the cap “pops” off when contacted by a user, during handling or dispensing, spilling the contents and contaminating the food or pharmaceuticals with which the container is packed.

Another problem with conventional containers is that the permeability of such containers often depends on holes formed through surfaces of the container. These holes often are large enough that dusting occurs, that is, particulate from the food or pharmaceutical and/or from the sorbent can clog the holes, thereby hindering permeability, or the dust can pass through the holes completely, contaminating the food/pharmaceutical, or having unintended consequences with the sorbent.

Thus, there is a need in the art for a “unitary” sorbent container that remains sealed during use, and does not run the risk of coming apart during handling. There also is a need in the art for a sorbent container usable in food and pharmaceutical products that significantly reduces and preferably eliminates contamination of the product by the sorbent material contained in the container. There also is a need in the art for a canister that allows a user to visually inspect the canister's contents.

### BRIEF SUMMARY OF THE INVENTION

It is an object of this invention to provide a sorbent container that overcomes one or more of the problems of sorbent containers in accordance with the prior art. It is another object of this invention to provide a sorbent container that is simple and inexpensive to manufacture.

It is another object of this invention to provide a sorbent container that is easy to assemble.

It is another object of this invention to provide a sorbent container that allows a user to readily see the contents of the container.

It is another object of this invention to provide a sorbent container that reduces or eliminates contamination of the product in which it is packaged from the contents of the container.

It is still another object of this invention to provide a sorbent container that is easy to fill with sorbent material.

Briefly stated and in accordance with one aspect of the invention, a sorbent container includes a permeable plastic container, a permeable membrane, and a sorbent. The permeable plastic container includes a sidewall and an endwall, the sidewall defining an opening opposite the endwall. The permeable membrane is fused to the sidewall to cover the opening. A fused junction is formed between the sidewall and the permeable membrane. The sorbent is disposed within the plastic container.

In accordance with another aspect of the invention, the sidewall has a different thickness than the endwall.

In accordance with another aspect of the invention, the endwall is transparent.

In accordance with another aspect of the invention, the fused junction is beveled.

In accordance with yet another aspect of the invention, a method of forming a sorbent capsule includes providing a porous plastic container comprising a sidewall and an endwall. The sidewall defines an opening opposite the endwall. The method also includes filling a portion of the porous plastic container with a sorbent through the opening, providing a permeable membrane, and fusing the permeable membrane to the sidewall to cover the opening and retain the sorbent in the container.

### BRIEF DESCRIPTION OF THE SEVERAL VIEWS OF THE DRAWING

The novel aspects of the invention are described with particularity in the appended claims. The invention itself, together with the further objects and advantages thereof, may be more readily comprehended by reference to the following detailed description of several preferred embodiments thereof taken in conjunction with the attached drawings, in which:

FIG. 1 is an exploded perspective view of a sorbent container according to a preferred embodiment of the present invention;

FIG. 2 is a perspective view of the sorbent container illustrated in FIG. 1;

FIGS. 3-6 illustrate a method of filling and assembling the sorbent container illustrated in FIGS. 1 and 2; and

FIG. 7 is a perspective view of a sorbent container according to another preferred embodiment of the present invention.

### DETAILED DESCRIPTION OF THE INVENTION

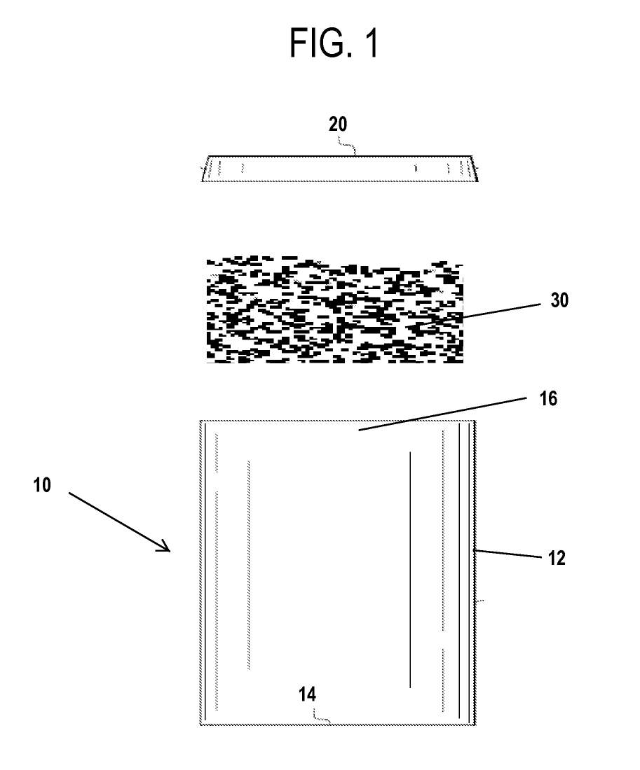

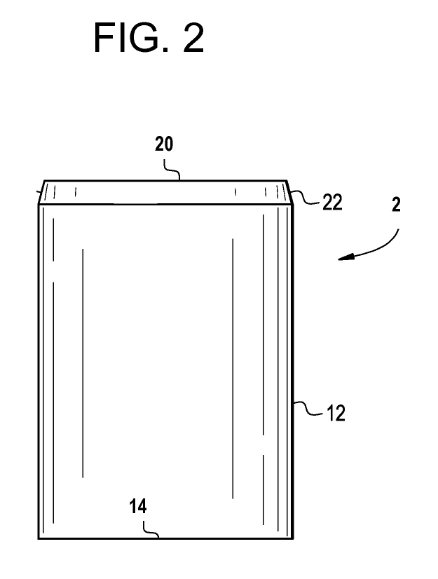

Referring now to FIGS. 1 and 2, a sorbent canister in accordance with this invention is illustrated. The sorbent canister 2 includes a container 10 and a cap 20 fixable to the container 10 to form a unitary structure, such as shown in FIG. 2. The container 10 is preferably, but not necessarily, cylindrical for ease of manufacture. The container 10 includes a sidewall 12 and an endwall 14. The sidewall 12 extends from the endwall 14 and defines an opening 16 opposite the endwall. The endwall 14 is shown as being relatively flat, but could be concave or convex, as desired. Preferably, the container 10 is formed at least in part from a material permeable to a gas that the sorbent canister 2 is designed to absorb, and more preferably, the entire container 10 is formed from such a permeable material. Examples of materials from which the container 10 may be formed include thermoplastic materials including but not limited to, polyethylene terephthalate, polyolefins, HPMC, or HDPE. Although these materials are preferred, any material, whether or not polymeric, that can be formed in the desired shape and exhibit the permeability necessary for the sorbent to act effectively in the application in which the container is employed may be used.

In a preferred embodiment, the container 10 is injection-molded. The injection molding process forms a dimensionally-controlled part with relatively fast through-put. Also in a preferred embodiment, the mold used to form the container 10 is sized to create a relatively uniform sidewall; that is, the sidewall 12 has a relatively uniform thickness. Similarly, the endwall 14 has a relatively uniform thickness. The thicknesses of the sidewall and endwall can be substantially the same, but in a preferred embodiment, they are different. In particular, the endwall 14 is thinner than the sidewall 12, and is thin enough so as to be transparent. More specifically, the endwall 14 is on the order of about 5-15 mils and the sidewall is on the order of about 35-60 mils.

By making the endwall 14 transparent, a user can visually inspect the sorbent contained within container, for example, to see if the sorbent is still working. As will be appreciated, sorbents with color changing agents have been developed that will change color when saturated with the material they are designed to absorb. The transparent endwall of the present invention allows for visual inspection of the sorbent. The sidewall 12 could alternatively be transparent, or both the sidewall 12 and the endwall 14 could be transparent. As noted above, in the preferred embodiment, the transparency results when the wall thickness is minimized. Other materials could alternatively be used that have better transparency.

The cap 20 preferably also is permeable to the gas that the sorbent is designed to absorb. In use, the cap 20 is disposed over the opening 16 of the container 10 to form a substantially sealed container 2 as illustrated in FIG. 2. In the illustrated embodiment, the cap 20 has a shape that corresponds to the shape of the housing 10. The cap 20 preferably is made of a permeable high-density polyethylene membrane. The membrane may be porous. The material comprising the permeable top must be selected to be compatible with the material comprising the container 10. That is, the two materials must be capable of being fixed to each other to form a canister having a unitary body. For example, and as will be described in more detail below, the permeable cap 20 is welded to the container 10, and it is thus required that the materials comprising the cap 20 and container 10 are capable of being welded to each other. In a preferred embodiment, the permeable cap 20 is bonded to the sidewall 12 over the opening 16. As more clearly seen in FIG. 2, the cap 20 is bonded to cover the opening 16 of the container 10 at a fused junction 22 by a fusion operation such as vibratory or hot tool welding. Before applying the cap 20, the container 10 is filled with a sorbent material 30 that can adsorb or absorb excess moisture, oxygen, odors, or other gas transportable material for which the sorbent material is designed to remove from its immediate environment.

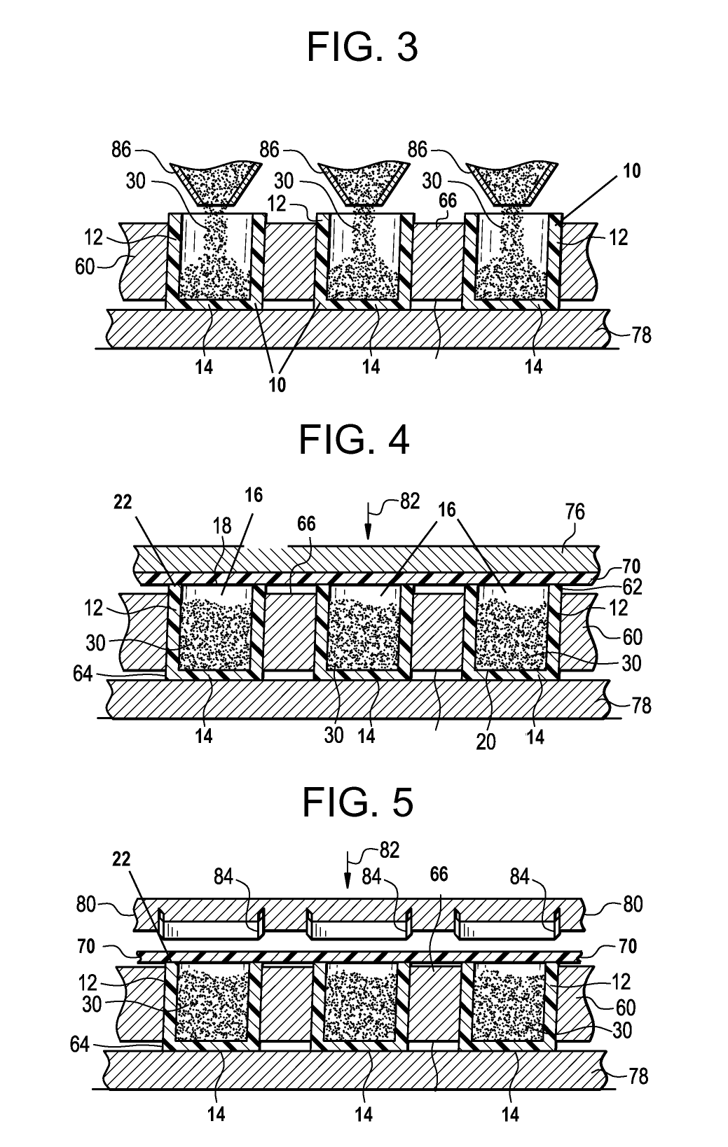

One method of forming the sorbent canister shown in FIG. 2 now will be described with reference to the remaining figures. As shown in FIG. 3, the containers 10 are first filled with a sorbent material 30. Once filled, as shown in FIG. 4, the injection-molded containers 10 are retained in a fixture 60 (such as in groups of 20) with only a very small end portion 62 proximate the opening 16 protruding beyond a surface 66 of the fixture 60. This causes the containers to be held securely during the subsequent welding operations. Thereafter, a permeable sheet 70 is laid across the opening 16 of the container 10. In an example embodiment, the sheet 70 is permeable high-density polyethylene. The sheet 70 preferably has a matte surface and a shiny surface, and the matte surface of the sheet 70 is placed in a contiguous relationship with the openings 16. The shiny surface could also be placed against the containers 10. Thereafter, a heated welding die 76 is applied to sheet 70 with sufficient heat and pressure to fuse together overlapping portions of the sheet 70 and the sidewall 12 at fused junctions 22. The welding die 76 is preferably formed from a rectangular bar of specialty steel (P20) with a hole formed along a longitudinal axis for inserting a cartridge fire rod. Another hole can be formed for inserting a thermocouple to provide feedback to a controller for maintaining the welding die 76 at a desired temperature.

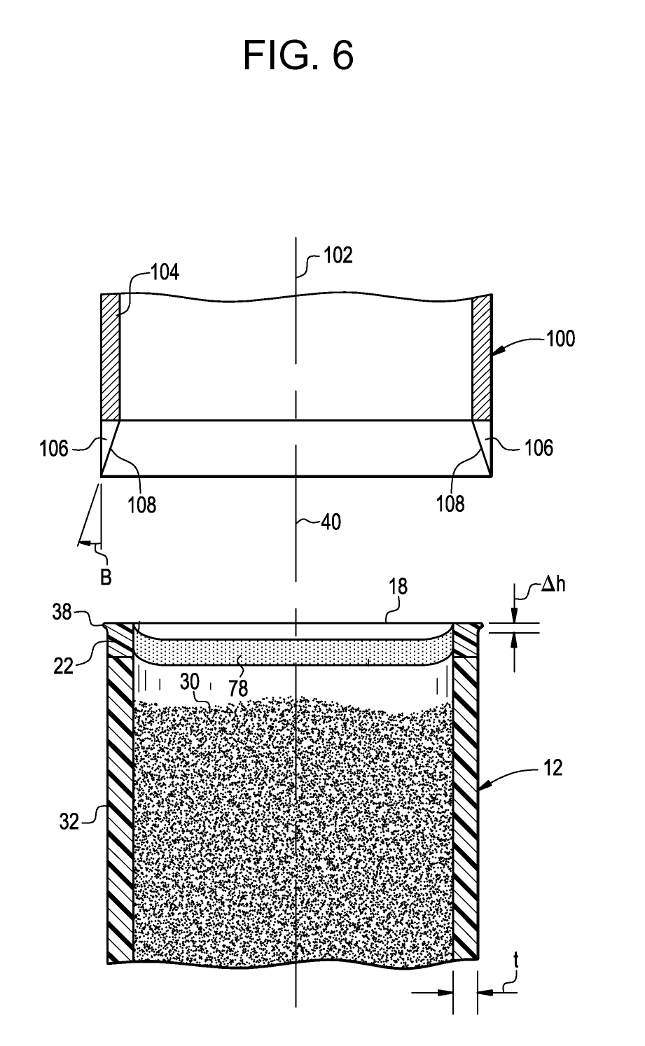

Although not apparent in FIG. 6, heat from the welding die 76 temporarily softens the sheet 70 in the vicinity of the fused junctions 22 so that uncompressed central portions 78 of the sheet 70 are drawn into the interior of the containers 10 and are joined to the sidewalls 12 at the fused junctions 22.

Preferably, the welding die 76 applies pressure in the direction of arrow 82 to the sheet 70 against the containers 10 between 200 and 1000 pounds per square inch, at a temperature of around 500 degrees Fahrenheit, and for a period of about 0.5 to 2.5 seconds. The sheet 70 is sufficiently stiff so that it will not buckle, tear, or split when subjected to the pressure. It is this combination of temperature and pressure that produces the fused junctions 22 for securely attaching portions of the porous plastic sheet 70 to the sidewalls 12 of the containers 10.

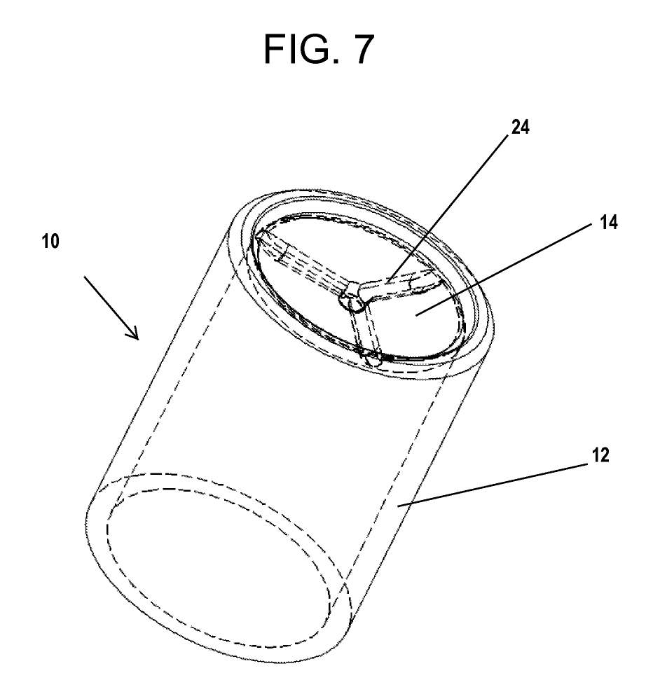

After the permeable sheet 70 has been bonded to the plurality of containers 10, a trimming die 80 is applied to the sheet 70, as depicted in FIG. 7, and excess material of sheet 70 beyond the peripheries of the containers 10 is trimmed away. As also shown in FIG. 7, the trimming die 80 contains a plurality of circular knives 84, which trim away the excess material of sheet 70 that lies outside the footprint of the sidewall 12.

In one embodiment, the sheet 70 is preferably made of porous high-density polyethylene appropriate for use in food or drug packaging. The sheet 70 is preferably 0.028 inches thick plus or minus around 0.005 inches. The porous sheet 70 can support airflows of 40 to 120 cubic feet per minute per square foot of area or 1400-4200 milliliters per minute through a one-inch diameter disc at a pressure of 1.2 inches of water. The sheet 70 has a preferred tensile strength of at least 215 pounds per square inch and should be sufficiently stiff so that the sheet 70 will not buckle, tear, or split when subjected to the forces encountered during the intended welding operations. Other values for tensile strength are possible depending on the desired application. Examples of such materials are available as roll stock from Porvair Technology of Wrexham, UK as Porvair PRLF094230, or Porex Technologies of Fairburn, Ga. as Porex Porous Products Group X-8054 or X-9474. Other porosities can be used, depending on the specific requirements of any particular application. In yet other embodiments, the sheet 70 may be a solid sheet, for example, of HDPE, that does not allow for airflow, but does allow for gas transmission. The sheet 70 material preferably is chosen to be a material compatible with the container 10, that, is, that is fixable to the container 10, to form the unitary sorbent capsule 2.

The heat welding process described above utilizes a clamping force or pressure of between about 600 to 1000 pounds per square inch, and it includes a heating time of approximately 1 to 2 seconds. The foregoing heat welding process causes fusion between the porous caps 20 and the sidewall 12 at the fused junctions 22. This fusion is obtained because interface areas of both the caps 20 and the hollow bodies 12 melt at substantially the same time under the foregoing circumstances notwithstanding their differences in porosity. Other bonding processes could also be used for attaching the cap 20 to the container 10, including vibratory welding processes such as disclosed in co-assigned U.S. Pat. No. 5,942,060, which is hereby incorporated by reference.

One of the preferred sorbent materials 30 is a silica gel having a particle size of about 0.5-1 millimeter available from Zhaoyuan Huiyuan Silica Gel Co. Ltd., of Zhaoyuan City, People's Republic of China, and the canisters 2 containing such silica gel are intended for use in adsorbing moisture in various environments, such as pharmaceutical containers, food containers, and in any other environments where moisture adsorption is desired. Other types of granular or non-granular gas or vapor treating material can be used, including by way of example and not of limitation such materials as activated charcoal, molecular sieve, activated clay, montmorillonite, calcium sulfate, and Clintolite and crystalline metal aluminosilicates. The canisters can also contain any other suitable product, including but not limited to conventional oxygen absorbing compositions, conventional carbon dioxide absorbing compositions. The canisters 2 can also contain liquid solutions containing sorbents or sorbents in cream or gel form, such as, but not limited to, carrageenan. The foregoing products absorb or adsorb gases from the environments in which the canisters 2 are placed. However, the canisters 2 can also contain products that produce vapors, which pass into the environment in which the canisters are located, and such vapors, by way of example and not of limitation, include fragrances, ethylene, and carbon dioxide. Therefore, the material within the canister body 12 will be characterized as “gas or vapor treating.” In addition or in place of sorbents, other components such as antimicrobial materials, antifungal materials, and the like may be employed. The sorbent container of this invention is exceptionally versatile and may be used in a wide variety of applications.

Once trimmed, the completed sorbent canister 2 is ready for use. However, it may also be desirable to add a bevel at the fused junction 22. Specifically, following the trimming operations or in conjunction with or in place of the trimming operations, a chamfering tool 100, as shown in FIG. 5, can be used to form a beveled surface 34 at the fused junction 22. The formation of the beveled surface 34 assures the removal of any untrimmed edges 38 at the ends of the canisters 2 that extend beyond the intended perimeters of the container 10 and that could interfere with the dispensing of the completed canisters 2.

The chamfering tool 100 is preferably rotatable about an axis 102 aligned with the central axis 40 of the containers 10 and includes a cylindrical body 104 and cutting blades 106 angularly spaced around the rotational axis 102. In addition, the chamfering tool 100 is preferably relatively translatable with respect to the canisters 2 along the rotational axis 102 and the central axis 40 for feeding the chamfering tool 100 into engagement with the fused junction 22 of the canister 2. Cutting edges 108 of the cutting blades are preferably inclined to the rotational axis 102 through an angle β for forming the beveled surface 34 at corresponding chamfer angles α.

Preferably, the chamfer angles α are less than 30 degrees. Even more preferably, the beveled surface 34 is inclined by chamfer angles of only approximately 15 degrees. The shallow chamfer angles α assure that the chamfering operation does not compromise a wall thickness “t” of the sidewall 12 despite height variations in the canisters 2. For example, a chamfer angle α at 15 degrees can accommodate nearly four times the height variation “Δh” as more conventional chamfer angles at 45 degrees. A tool stop can be referenced with respect to the fixture 60 to set the cutting depth of the chamfering tool 100. Two cutting blades 106 per tool are preferred. Rotational speeds of between 700 and 1500 revolutions per minute (RPM) are also preferred. The vertical feed of the chamfering tool 100 along the rotational axis 102 is preferably variable in speed to provide a rapid approach but slower feeds during cutting.

Either the chamfering tool 100 can be translated between canisters 2 or multiple chamfering tools 100 can be used for chamfering the ends of the plurality of canisters 2 within the fixture 60. Multiple chamfering tools 100 could also be used together with individual or collective translation of the multiple chamfering tools 100 to index the chamfering tools between canisters 10. For example a five-head spindle could be used for chamfering 5 canister ends at one time, and the entire five-head spindle could be indexed to chamfer another set of five canister ends within the same fixture 60. The chamfering tools 100 can be used in addition to or as a replacement for the trimming die 80. That is, the chamfering tools 100 can be used (a) to cut through the porous sheet 70 for separating the canisters 2 from the sheet 70 and (b) to continue cutting (i.e., relatively translating along the rotational axis 102) to form the beveled surface 34 at the fused junction 22.

As described above, both the material used to make the container and the material used to make the cap 20 preferably are permeable. They may be porous, but such is not required so long as the canister 2 is capable of absorbing or adsorbing according to the intended application. The container 10 and the cap 20 may be made of the same material but such is not required, so long as the two can be affixed to each other, as described in more detail above. The materials may be selected such that both the container 10 and the cap 20 have similar permeability or they may be very different. For instance, it may be desirable that the bulk of absorption/adsorption is to be done through the cap, so the cap 20 is made of a material having a much higher permeability than the material making the container 10.

As will be appreciated, once the cap 20 is fused to the container 10, the canister 2 is a unitary structure containing a sorbent, and the sorbent cannot be accessed short of destroying the canister. This is in contrast to prior art canisters in which one or more ends can be popped off, resulting in sorbent spillage.

Although FIGS. 3-6 depict one method of making the sorbent canister 2, other methods also could be used. For example, the containers 10 could be individually capped with a membrane that approximates the size of the opening 16. In this manner, there will be no excess material requiring trimming, thereby minimizing waste. In addition, the cap 20 could be a thin injection-molded part that is welded or otherwise fixed over the opening 16 defined by the sidewall 12.

Because the container 10 is injection-molded, additional structures may also be built into the mold. For example, in FIG. 7, ribs 24 are provided in the container, extending outwardly from a center to the sidewall 12. These ribs may help in production of the part, i.e., by assisting flow of the injected material into and through the mold. Moreover, the ribs add stability to the structure. When the ribs 24 are provided at the endwall 14, as shown in FIG. 6, the endwall will be thicker at the ribs 24, and thus will not have a uniform thickness. Moreover, the ribs 24 likely will not be transparent. Of course, the ribs may be placed anywhere along the length of the sidewall 12, not necessarily at the endwall 14.

While the invention has been described in connection with certain presently preferred embodiments thereof, those skilled in the art will recognize that many modifications and changes may be made therein, without departing from the true spirit and scope of the invention, which accordingly is intended to be defined solely by the appended claims.

1. A sorbent canister comprising:
a permeable plastic container comprising a sidewall and an endwall, the sidewall defining an opening opposite the endwall;
a permeable membrane fused to the sidewall to cover the opening;
a fused junction between the permeable membrane and the sidewall; and
a sorbent within the plastic container.

2. The sorbent canister of claim 1, wherein the permeable plastic container is injection-molded.

3. The sorbent canister of claim 1, wherein the endwall is transparent.

4. The sorbent canister of claim 3, wherein the sidewall is opaque.

5. The sorbent canister of claim 1, wherein the endwall is thinner than the sidewall.

6. The sorbent canister of claim 1, further comprising a beveled surface formed at the fused junction.

7. The sorbent canister of claim 1, further comprising one or more ribs extending to the sidewall.

8. The sorbent canister of claim 1, wherein the sorbent is a granular sorbent.

9. The sorbent canister of claim 1, wherein the sorbent is a liquid sorbent.

10. The sorbent canister of claim 1, wherein the container has a first permeability and the permeable membrane has a second permeability, different from the first permeability.

11. The sorbent canister of claim 1, wherein the sorbent is one of a cream and a gel.

12. A method of forming a sorbent capsule comprising:
providing a permeable plastic container comprising a sidewall and an endwall, the sidewall defining an opening opposite the endwall;
filling a portion of the permeable plastic container with a sorbent through the opening;
providing a permeable membrane; and
fusing the permeable membrane to the sidewall to cover the opening and retain the sorbent in the container.

13. The method of claim 12, wherein the fusing step creates a fused junction and further comprising beveling the fused junction.

14. The method of claim 12, wherein the endwall has a first thickness and the sidewall has a second thickness, different from the first thickness.

15. The method of claim 12, wherein the container has a first permeability and the permeability membrane has a second permeability different from the first permeability.

16. The method of claim 12, wherein the endwall of the container has a first thickness and the sidewall of the container has a second thickness different from the first thickness.

17. The method of claim 12, wherein the endwall of the container is transparent.

18. The method of claim 12, wherein the sorbent is a granular sorbent.

19. The method of claim 12, wherein the sorbent is a liquid sorbent.

20. The method of claim 12, wherein the sorbent is one of a cream and a gel.
